(19) United States
(12) Patent Application Publication
(10) Pub. No.: US 2005/0092826 A1
(43) Pub. Date: May 5, 2005

(54) Disposable financial tools (DFT) / Yfee

(76) Inventor: Lee Blackman, Brooklyn, NY (US)

Correspondence Address: Lee Blackman, 601 Park Place, Brooklyn, NY, 11238, US

(21) Appl. No.: 10/694,718

(22) Filed: Oct. 29, 2003

(51) Int. Cl. G06K 5/00

(52) U.S. Cl. 235/380

(57) ABSTRACT

Disposable Financial Tools (DFI)/Yfee: Is a financial system that combats credit card and check fraud, preventing Identity thief and financial terrorism. Has a single working life, when used to make a purchase or other transaction, it cannot be reused or redeposit. Comes in 3 flavors, sleek check, Sleek Card and IEIcard. Their secondary numbers are automatically altered or lock from the network after gaining access and process. The secondary numbers drop off and die as a built in safety. Sleek Check: Is a check and credit card look-alike and carries a Sleek number. It is used for making payment with merchants in person. Can be architecture to pay an individual. IEICard has a Queen and Jones number, for Web and Telemarketing purchases. Sleek Card: It is used for making purchases in person and come in two flavors. Regular Card and Gift Card.

### BACK GROUND OF THE INVENTION

Present invention relates to financial tools, particularly those tools that are used to access cash or credit electronically and none electronically. More particularly, the invention relates to Disposable Financial Tools (DFT/Yfee).

Many financial tools, for example, a single Credit card, can be used multiple times or check can be re-deposited multiple times if it is bounce. They do not ensure safe access to the account. They ensure access to the account as long as the routing number, transit number, account number and check number are correct, and there is enough cash or credit in the account to cover the transaction, a signature, fake or real, and sometimes no signature is required (off-line), but the transaction will be approved.

Even in person a credit card can be used other than the account holder or holder name that is on the card. In such case, the user only needs to get an approval after processing, while the merchant only look forward to an approval and sometimes match the signature. With a check, most of the time the payee only fines out after it has been deposited, that the check has been bounce, fake, or stolen.

In many cases, the only thing that is needed is enough cash for the check to be cleared or credit for the transaction to be approved.

The safety of present financial tools is left to the payee or merchant to determine if the check/credit card is the rightful owner of the payer. the account number is publish on the check, credit card, and sometimes invoice or receipt when a purchase is made, making them venerable for fraud and counterfeit. Merchants have the power to enter any amount when making a payment or purchases, without the account holder being present (offline).

### BRIEF SUMMARY OF THE INVENTION

It is an object of the invention to provide Disposable Financial Tools (DFT) that have a single working life and access to a fix cash or credit amount. When used to make a purchase, it cannot be reused to make another purchase or redeposit. A method of implementing such a system includes providing secondary numbers on DFT that are automatically altered or lock from the network after gaining access and processing, In order to prevent a DFT with the same sets of number from gaining access to the network again. The secondary numbers are altered or drop off or die as a built in safety, whenever the secondary numbers on the Yfee are marching the routing number, transit number, PYN and secondary numbers that are on the network. DFT does not carry an account number unlike checks and credit card. Not all DFT will have a single use or working life when making a purchase. A financial system that combat fraud and financial terrorism. Financial tools that can make purchase without the account holders warring about someone stilling their accounts number.

The foregoing and other objects, features, and advantages of the invention are now apparent from the following, particularly those descriptions of preferred diagrams of the invention as illustrated in those accompanying drawings.

### BRIEF DESCRIPTION OF THE DRAWING

FIG. 222 show a front view of a sleek check with the holder and Issuer name. ATV#, space for placing Ads, and Sleek check stub.

FIG. 223: shows a back view of a sleek check with space for Ads, payee name, memo, and authorized signature, Issuer name and address, Sleek check web address, expiration date and a magnetic strip covering the routing and transit number, PYN, ATV, and Sleek number.

FIG. 224 is showing a Sleek check receipt after a transaction is completed and approved.

FIG. 225 is a front view of a Sleek card, where third party logo and other drawing will be place.

FIG. 226 is a view of an illustrated primary holder Sleek card appearance.

FIG. 227 is an illustrated front view of a Sleek-G for placing Companies Ads and other drawings.

FIG. 228 is an illustrated diagram showing a front view of a Sleek-G (sleek card gift card), with a space for the reception to write his name as the payer and sign as the authorized signature on the card.

FIG. 229 is an illustrated diagram showing a Sleek card receipt after a transaction is process and approved.

FIG. 230 is a diagram showing an IEIcard with its Queen and Jones number. The Queen number is made up of the Routing number transit number and PYN. The Jones number is a Serial or an ATV number.

FIG. 231 is an illustrated diagram showing how the IEIcard looses its Jones number every time a transaction is completed.

FIG. 232 is a diagram showing a web page with a $50 purchase and a purchase order number to be submitted by the purchaser to the IEIcard system (Disposable Financial Tools) or Lender for processing.

FIG. 233 is an illustrated diagram showing an IEIcard web template for prospective buyers to fill out when making a web purchase. Prospective buyers can check the license or registration number of a seller, to see if he is license or register with Disposable Financial Tools (DFT/Yfee) Network, before making any purchase.

### DETAILED DESCRIPTION OF THE INVENTION

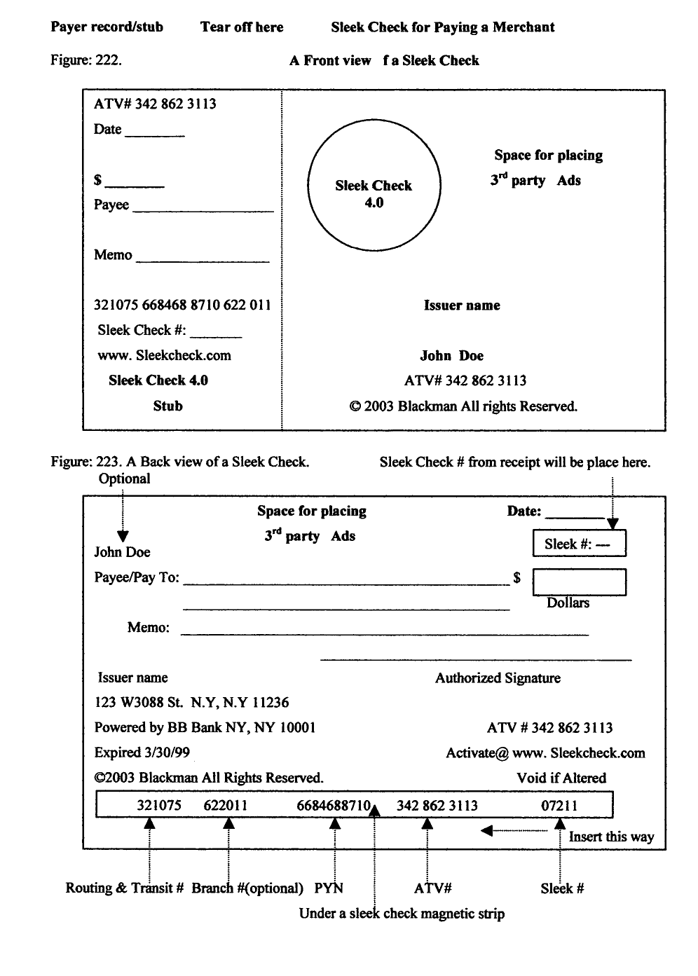

Now referring more particularly, to the drawings, indicating the parts and structural features in the various diagrams. It illustrates the diagrams of the present invention Yfee/Disposable Financial Tools (DFT): Financial tools that have a single working lif, when used to make a purchase or other transaction, it cannot be reused to make another purchase or redeposit. The secondary numbers are automatically altered or lock (exile) from the network after gaining access and processing. In order to prevent a DFT with the same sets of number from gaining access to the network again. The secondary numbers drop off and die as a built in safety, whenever the secondary numbers on the Yfee are marching the routing number, transit number, PYN and secondary numbers that are on the network. DFT does not carry its account number on it, unlike checks and credit cards. Not all DFT will have a single use or working life when making a purchase. Yfees are used for making purchases with merchants in person, on the World Wide Web and with Telemarketers 24×7 anytime anywhere Universally. Yfee come in 3 flavors, sleek check, Sleek Card and IEIcard. Sleek Check: Is a check and credit card look-alike. See FIGS. 222 and 223, it is sometimes called a none-deposited disposable check (NDDC) or Avycheck (advance check). Sleek Check is not a credit card or check and it is neither a ticket, although it seems to have a slight way in which it works that may look like a ticket FIG. 222 show a front view of a sleek check FIG. 223: shows a back view of a sleek check. Sleek Checks are used for making purchase or payment in person with merchants. It can also be architecture to pay an individual. Sleek Check carries a unique number called a sleek number. But the number does not follow in the order unlike conventional check numbers e.g. 1102, 1103, 1104. With conventional check, the next number after 1104 would automatically be 1105, but with a Sleek Check the following number would never be 1105 or may not have 1105 as part of the sleek number. The routing and transit number, sleek number, PYN, and the ATV# will be hidden under the magnetic strip. See FIG. 223. The ATV number and Sleek number will be different on every Sleek Check.

How does it work: Sleek check performs electronic transaction. And work 50% like a check and 50% like a credit card and comes in paper or plastic form. It can be architecture in a credit or none credit form. A Sleek Check working life is valid for a single use only. The payee does not endorse it unlike a conventional check. Sleek Checks are used for making purchases in person only.

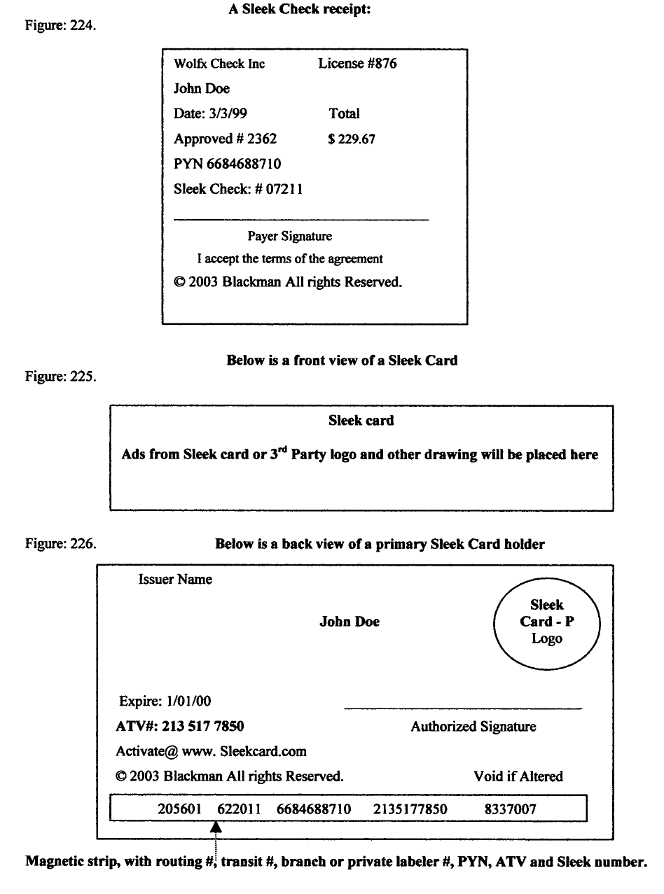

To make a purchase, the payer will write the date, payee name, total amount of the purchase in figures, and words, words optional, then sign his name on it, then tear it off and give it to the cashier. (Works like a check). The cashier will swipe the magnetic strip into the CUPM (Convenient Universal Payment Machine) or credit card machine then press enter. (Works like a credit card). Then enter the amount that is written on the Sleek Check. If the cashier gets an approval, a receipt will be printed with the merchant name and license number, approval#, payer name, date, Sleek number, PYN and the amount approved, for the payer to sign. After the transaction is completed, both the merchant and the payer will keep a copy of the sign receipt. See FIG. 224.

Paying an individual: The payee must have an existing bank account and obtain an individual/personal credit processing account (ICPA/PCPA) or CUPM and sleek check license. The Sleek check is process unlike a credit card and must be activated by the payer before such process can take place.

T activate a sleek check, the payer can use a CUPM, ATM, phone or the web and enter the PYN/ID#, ATV#, and enter his Pin#, then press enter, enter the cash amount written on the sleek check, then press enter. You will hear or see e.g. the amount e.g. $50 is activated. Then enter the payee PYN and the amount that is written on the sleek check, then press enter. If it is successful, you will hear or see e.g. the amount e.g. $50 is approve on PYN/ID#413 614 3920 or approved. The payer will write on the Sleek check next to memo, for payee PYN 413 614 3920 and whatever else he chooses. The payee will check his account to find out if there are any funs available for depositing. If there is, he will press a number or letter to deposit the amount with the information provided by his Lender.

PYN: payment number or personal payment number/PPN. Is a universal financial identification number (UFIN) that identify an individual anywhere in the world using a Subcbeck, Lfee, Sleek check, Sleek card, Avyheck (advance check), Sleepy check (lazy check) or Yfee. The number is used for making payment or deposits on accounts only. The advantage of the UFIN, if someone barrowed $1000 from a bank in the U.S and moved to another country, if he try's to set up an account with a financial institution he can be trace from point A to B, using the same PYN/UFIN, because UFIN is issued only once to an individual. Sleek Check features and tools can be applied to current conventional checking system.

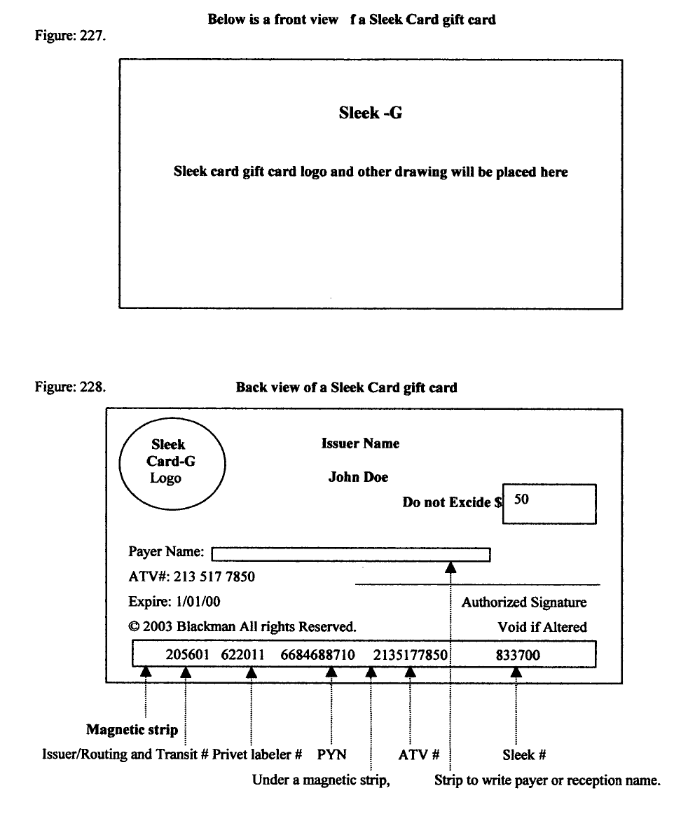

Sleek card (Mini/Midget-Check): Is a disposable financial card that gives access to cash or credit. It is used for making purchase in person and come in two (2) flavors, Regular card and Gift card. Sleek card may carry's an expiration date, but the date is not part of the transaction. The date is used to reminds the cardholder that his card will be expiring at a given time. See FIGS. 225 and 226 for a front and back view of a regular Sleek card-P. FIGS. 227 and 228 show a front and back view of a Sleek Card gift card (Sleek-G).

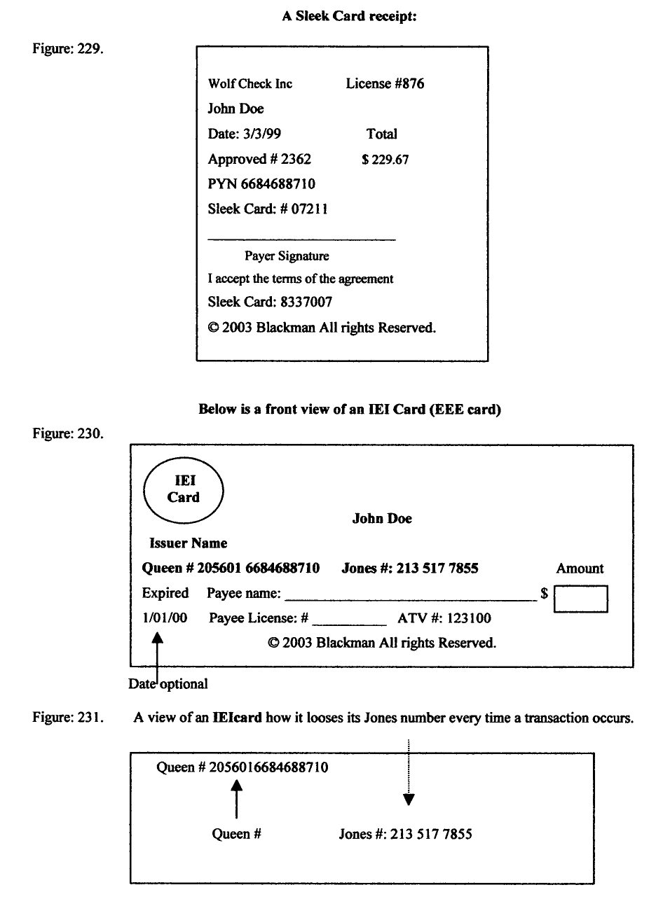

Making purchases: To make a payment, the cardholder will give the cashier his Sleek card. The cashier will swipe the card into the credit card machine or CUPM and press enter, then enter the total amount of the purchase and press enter. If the transaction is approved a receipt will be printed, the cardholder will sign it and both him and the merchant will keep a copy. See FIG. 229. The card is given back to the holder. Sleek card Gift cards are given as gifts. The account holder will write the name of the gift card reception as the payer's name, the amount of cash or credit the card will have access to, e.g. $50 in the box next to DO not Excide or pay exactly. See FIG. 228. The person receiving the Sleek-G will write his signature next to authorized signature. A Sleek-G may have up to 5 usages maximum on a single card. Whenever a Sleek-G is used, the cashier will see the amount that has been used and how many times it has been used. IEIcard: Is an Internet payment card (IPCard/Eeecard), See FIG. 230.

It is used for making payment and purchases on the web and with Telemarketers. It comes in two flavors, regular and ISP. ISP is used for signing-up or payment for Internet service. There are four such cards in every IEIcard sets or pack.

The cards are use for quarterly billing or 3 months billing. Every time one is used, the Holder is automatically billed three times, for the same amount. An IEIcard uses its Queen and Jones number.

Regular IEICards are used for general purchases on the web. FIG. 231 is an illustrated diagram showing how an IEIcard work and looses its Jones number every time a transaction is completed.

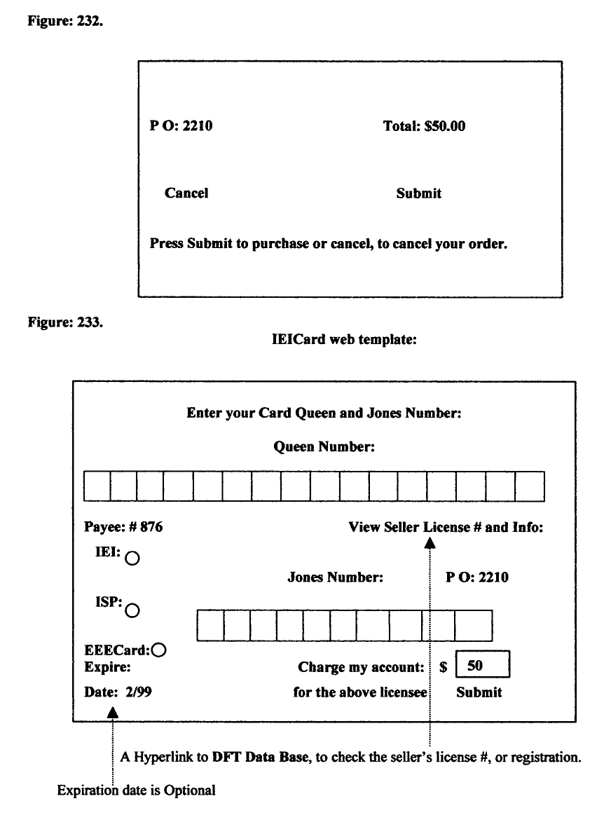

Regular web purchase: To make a web purchase, after the cardholder choose the items and submit them with the total cost e.g. $50, and the payer name and address, to the seller web site, the total cost will pop-up again on a new page With a purchase order number e.g. 2210, see FIG. 232. All that is done on the merchant web site. The shopper will press submit, that will take him to the Lender or IEICard web site, where he will see the Purchase order number and the $50 submitted, will now be on the IEICard web template. He will enter the, Queen number, Jones number and type of card. See FIG. 233. The $50 is not up-loaded by the merchant for payment unlike credit card. The payer himself is the one that makes the request or ask his lender or IEIcard system to charge his account $50 on behalf of the Licensee or merchant. The lender will deposit into the merchant bank account the amount submitted by the payer ($50). Making purchase with a Telemarketer, the cardholder will give his name and address, queen number, Jones number and ATV number. After the transaction is completed the payer will write the payee name and license number on the card. The Telemarketer will receive payment by entering the Queen number, Jones number, and ATV number through a web portal. The Queen number is made up of the Routing number, transit number and PYN. The Jones number is a Serial or an ATV number (secondary number).

Advantages: Disposable Financial Tools (DFT) or Yfee are disposable, their working lives are valid for a single use only. When used, the secondary numbers are automatically altered or lock from the system. If someone tampers with the Magnetic strip and tries to reuse them, they would be useless because the secondary numbers are no longer exist or working. They are dead. That will help combat fraud and financial terrorism by tailoring Yfee to a single use only. If for some reason an Yfee is fraudulently used, it is limited to a single use or purchase only. If you used one and someone gets the secondary numbers and your pin number, it will be imposable to produce one that will work, secondary numbers does not run in order unlike check numbers. Yfee used an individual UFIN to monitor the user on its network. The serial and ATV number are used with Checkact to lock and unlock an Yfee. Yfee have many advantages over a credit card. The only advantage of a credit card is a single card for multiple-usage. That makes it venerable for fraud and financial terrorism. A Credit card has many disadvantages. A Cardholder can be billed and rebilled multiple times with a single credit card by the same merchant for the same thing or many different things. An Internet Service Provider (ISP) is a prime example. A subscriber is billed every month with the same credit card, if that Subscriber shops at his ISP shopping site, he will be billed by his ISP without ever entering his credit card information a second time on the ISP web site. Sometimes he even billed for something he never order or purchase. Merchants with that type of power over credit cards can run up someone credit to the Maximum. A merchant have the power to enter any total amount offline, all he need is the holder's name and some times his address, card number, expiration date and an approval for the amount he enters. A disgruntled employee can walk away with your credit card information and make unlimited purchases untilled the account is run out of credit and put your credit in financial disaster, or until he is caught, just by using a single card. Using a check, it has to be deposited and cleared before you can get the funs. Someone can write a bounce check and the payee have to pay for it. A check holder's signature can be forge. But with Yfee the account holder have the option to choose which, when, and how many Yfee and the cash or credit amount he want to make available to the Yfee by using Checkact which allowed you to lock or unlock an Yfee. Credit card does not have such privilege.

Yfee can be issue as an independent financial system or with a checking, saving or credit card account.

1. The method of a queen number is made up of the Routing number, transit number and PYN. The Jones number (secondary number) is a Serial or an ATV number.

2. The methods of making payments with Disposable Financial Tools and the way in which they work.
Sleek check works 50% like a check and 50% like a credit card.
The payee does not endorse it, neither deposit it.
A Sleek G card, the cashier can see how many times the card has been used and total amount used.
The cashier cannot exceed the amount written on the Sleek G, if the primary holder activates it, using Checkact.
When a IEIcard holder making a web purchase, the purchaser himself is the one that makes the charges or request for payment with the IEIcard issuer or lender on behalf of the Licensee or merchant. The merchant does not store up IEIcard Queen or Jones numbers and does not have any access to the secondary numbers on the lender or leicard system web site.
IEIcard ISP is used for quarterly billing, any time one is used, the holder will be billed automatically three (3) times for the same amount.

3. The method of an IEIcard web template, purchaser can view the merchant license number, phone number and address, to see if it is genuine.

4. The method of processing Disposable financial tools using a control function, that when secondary numbers gain access, process and approved, they become disabled and altered or drop off or lock and exile automatically from the network, as a built in safety. In order to prevent a DFT with the same sets of secondary number from gaining access to the network again.

5. Disposable Financial Tools (DFT) or Yfee. Financial tools that have a single working life, when used to make a purchase or other transaction, it cannot be reused to make another purchase or redeposit.
